(19) United States
(12) Patent Application Publication
(10) Pub. No.: US 2006/0293106 A1
(43) Pub. Date: Dec. 28, 2006

(54) Double inserted U-joint seal

(75) Inventor: John Brian Wagner, Greenfield, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/166,681

(22) Filed: Jun. 24, 2005

(51) Int. Cl. F16D 3/00

(52) U.S. Cl. 464/133

(57) ABSTRACT

The present invention relates to a seal used in a U-joint assembly. A compressible annular seal has two annular legs radially spaced apart with a rigid insert at least partially disposed within each leg to provide a desired loading. The inner leg creates a first loading against the relatively stationary surface of a trunnion of a U-joint to provide a static seal. The outer leg creates a loading, lighter than the first loading, to provide a dynamic seal against the relatively moveable surface of a cup of a U-joint. The seal may include a bridge that allows for relative movement and variations in loads between the legs.

### FIELD OF THE INVENTION

The present invention relates to seals, and particularly to seals in a U-joint assembly and methods for preassembling a U-joint.

### BACKGROUND OF THE INVENTION

U-joint assemblies are used to couple rotating members together and accommodate rotation about intersecting axes. Each rotating member has a pair of yokes that are coupled together with U-joint assemblies. U-joint assemblies include a spider with four co-planar trunnions extending from a base and four cup assemblies secured to each of the trunnions. The cup assemblies utilize a seal to secure a spacer, roller bearings, and grease within a cup. The seal can also be used to secure the cup assembly to the trunnion. The cup assemblies may be a grease for life structure wherein there is no provision for adding additional grease after assembly.

The U-joint assembly allows for an angular deviation between the axes of rotation of the components. Due to the angular deviation, the velocities of the U-joint components vary over a single rotation. For example, the angular deviation can cause the U-joint components, such as a yoke, of a driven member, such as a shaft, to speed up and slow down twice in each revolution. The effect of this angular deviation can wear out U-joints and, in particular, the seals and decrease the life span.

Typical U-joint seals form a dynamic seal against the trunnion and a static seal against the cup. The seal retains the grease within the assembly while keeping contaminates out. Grease is vital to the life span of the U-joint assembly. If the assembly lacks grease, the assembly can wear out prematurely. The assembly can also prematurely wear out with the insertion of contaminates. Contaminates can include water, which may lead to rusting of the bearings, and dirt. Thus, it would be advantageous to use seals that maintain the grease in the assemblies and prevent contaminates from entering the cups.

During the preassembly of a U-joint, the cup assemblies are secured to the trunnions of a spider and these U-joint assemblies are transferred to a final assembly location for insertion within the yokes. With the traditional configuration, where the seal dynamically seals to the trunnion, the cup assemblies may fall off. This can increase the time needed to couple the yokes together and increase the assembly costs. Thus, it would be advantageous to provide a seal that securely maintains the cup assemblies to the trunnions.

### SUMMARY OF THE INVENTION

The present invention discloses and teaches a seal that advantageously statically seals against the trunnion and dynamically seals against the cup. The static seal gives the cup assembly a strong seal against the trunnion and reduces the frequency of the cup assemblies falling off the trunnions while being transferred to a final assembly location. The static sealing to the trunnion and the dynamic sealing to the cup also advantageously reduces the loss of grease from within the cup and minimizes the possibility of contaminates entering into the cup assembly. The seal of the present invention thereby improves the longevity of the U-joint assembly and facilitates the assembling of the U-joint assembly.

In one aspect of the present invention, a seal includes a compressible retaining member having two legs radially spaced apart. Each leg has at least one sealing surface. A rigid insert is at least partially disposed within each of the legs to limit the radial movement of at least a portion of each of the legs.

In another aspect of the present invention, a seal has two legs. One of the legs is operable to provide a static seal against a relatively stationary surface. The other leg is operable to provide a dynamic seal against a relatively moving surface. A flexible bridge interconnects the two legs and allows for relative movement between the two legs.

In yet another aspect of the present invention a sealing system for a U-joint is disclosed. The sealing system includes a compressible sealing member with radially opposite inner and outer perimeters. The inner perimeter is operable to engage with and seal against the U-joint trunnion. A rigid annular member is at least partially disposed within the sealing member. The annular member limits radially outward movement of a portion of the inner perimeter of the sealing member. The sealing member and the annular member form an interference fit on a U-joint trunnion.

In another aspect of the present invention, a method of preassembling a U-joint is disclosed. The method includes: (1) securing a compressible sealing member on a cup with a portion of the sealing member engaging a wall of the cup; (2) positioning the cup and the sealing member on a trunnion; (3) forming a compressible interference fit between the sealing member and an outer surface of the trunnion thereby retaining the cup, the sealing member, and the trunnion together as a secured assembly; and (4) moving the secured assembly to a final assembly location.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a shaft having a U-joint assembly and a seal according to the principles of the present invention;

FIG. 2 is an exploded view of the U-joint assembly of FIG. 1 and the yokes;

FIG. 3 is an exploded view of the seal used in the U-joint assembly of FIGS. 1 and 2;

FIG. 4A is a partial cross-sectional view of the U-joint assembly along the line 4-4 of FIG. 1;

FIG. 4B is an enlarged cross-sectional view of a portion of the U-joint assembly within circle 4B of FIG. 4A; and

FIG. 5 is a flow chart of the method of preassembling a U-joint according to the principles of the present invention.

### DETAILED DESCRIPTION OF THE PREFERRED EMBODIMENT

The following description of the preferred embodiment is merely exemplary in nature and is in no way intended to limit the invention, its application, or uses.

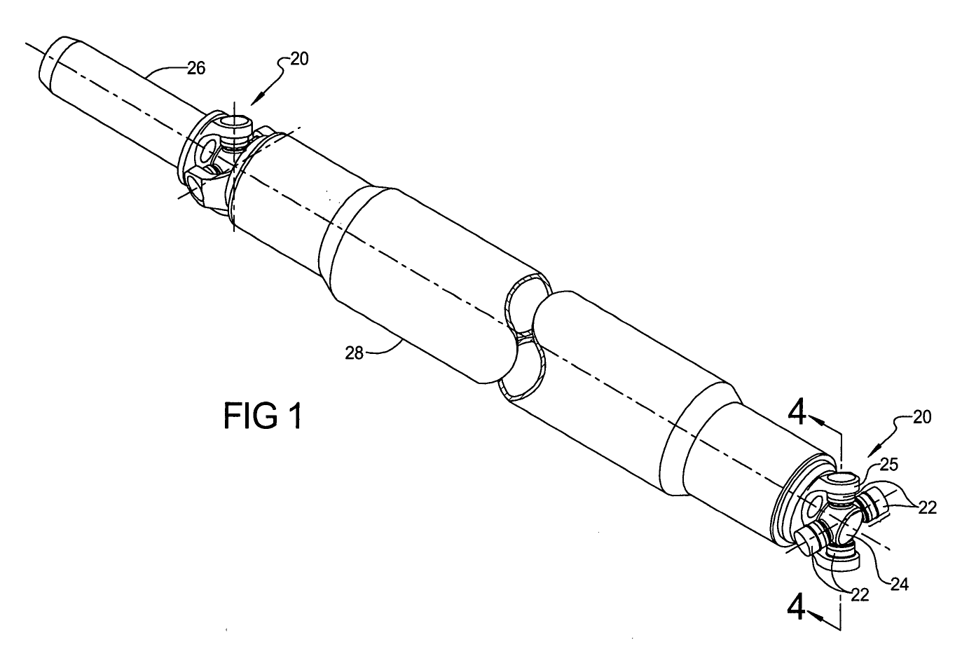

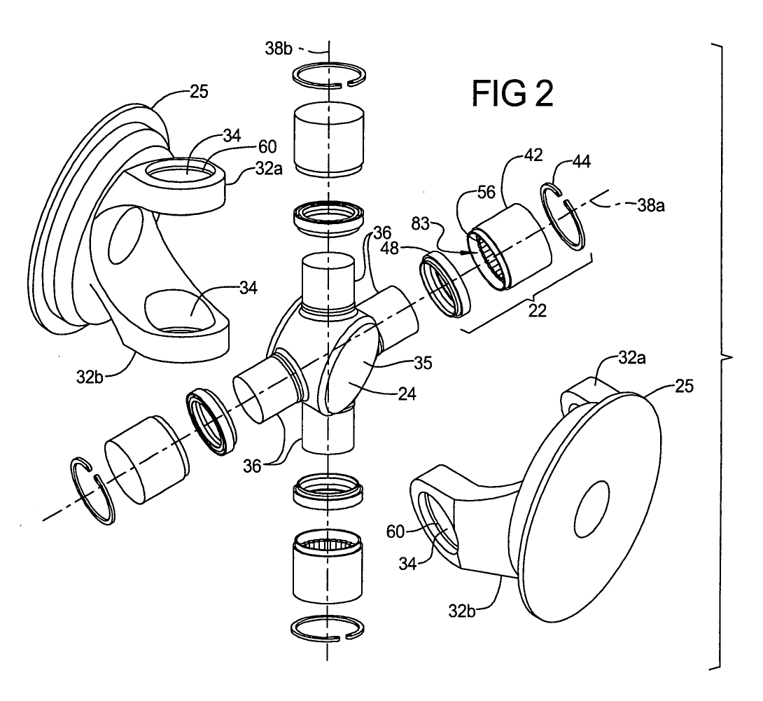

U-joints 20, operable to interconnect two rotatable components 26, 28, such as rotatable shafts, according to the principles of the present invention are shown in FIG. 1. U-joints 20 allow for translating rotation of one component into rotation of the other component. The details of U-joint 20 are shown in FIG. 2. Each U-joint 20 includes four cup assemblies 22 and a spider 24. U-joint 20 is disposed within a pair of yokes 25 that are attached to the ends of components 26, 28. Each yoke 25 includes two arms 32a, 32b with axially aligned openings 34. Yokes 25 on each component 26, 28 are positioned at right angles to each other and are interconnected through spider 24 and cup assemblies 22. Rotation is transferred from one component 26 through its yoke 25, cup assemblies 22, spider 24, and the other yoke 25 to the other component 28. Components 26, 28 can rotate about different axes.

Spider 24 includes a center portion 35 with four cylindrical arms, hereinafter referred to as trunnions 36, extending outwardly from center portion 35. Trunnions 36 are equally spaced apart around center portion 35 at 90 degree intervals and form two pairs of trunnions that are aligned along respective axes 38a, 38b. Each aligned pair of trunnions 36 is disposed within aligned openings 34 of one of the yokes 25 in the final assembly.

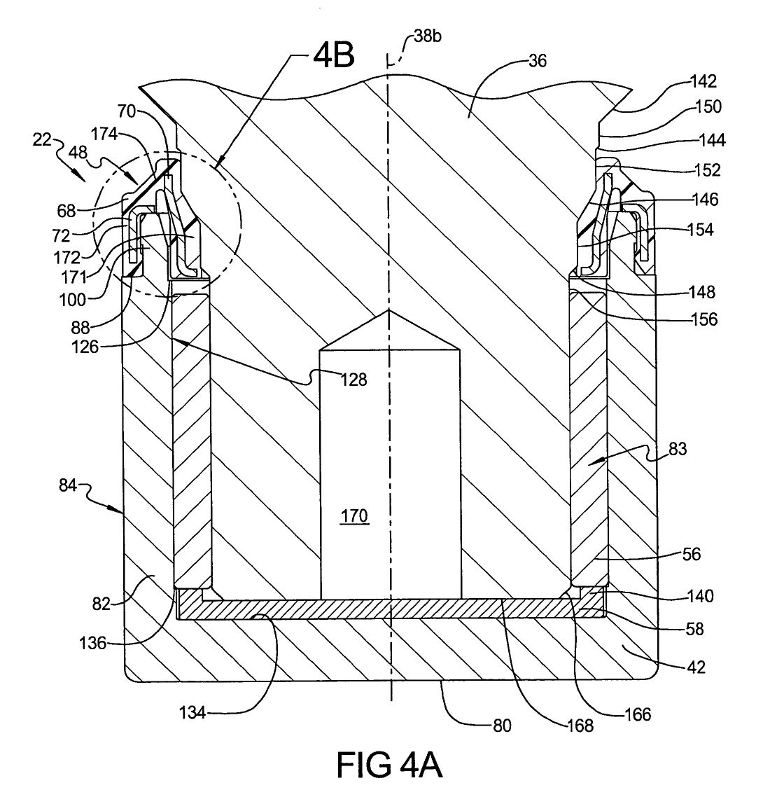

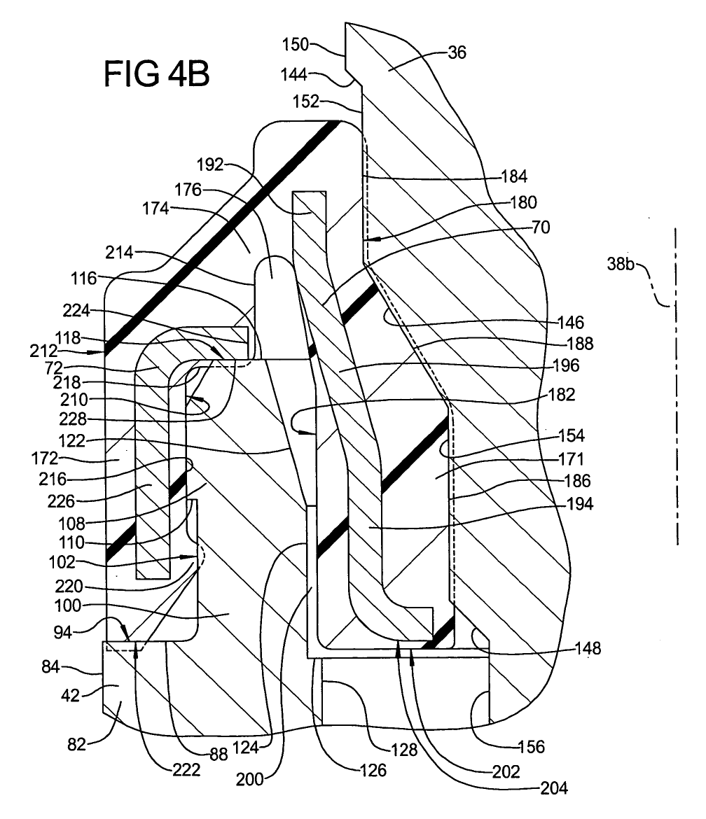

Cup assemblies 22 are disposed on each trunnion 36 within one of the openings 34 in yokes 25 in the final assembly. Each cup assembly 22 includes a cylindrical cup 42, a retaining clip 44 and a seal 48. Roller bearings 56, a spacer 58 (shown in FIG. 4A), and grease are disposed within each cup 42. Bearings 56 and the grease allow for relative movement between trunnion 36 and cup 42. Relative movement between cup 42 and trunnion 36 results from angular deviation between the axes of rotation of components 26, 28. Cup 42 oscillates back and forth during rotation due to the angular deviation between the linked components. For example, when the angular deviation is about 6°, cup 42 may oscillate back and forth about ±6° relative to trunnion 36.

Seal 48 secures cup 42 to trunnion 36. Seal 48 engages a wall of cup 42 and trunnion 36, as described below. Cup 42 and seal 48 form a shield around bearings 56 that keeps grease within and contamination out of cup 42 when secured to trunnion 36. Retaining clip 44 is C-shaped and locks cup assembly 22, when secured to trunnion 36, within openings 34 of yokes 25. Specifically, clip 44 locks into an annular recess 60 in each yoke arm 32 and engages with the bottom surface of the cup 42 to thereby lock cup assembly 22 within yoke 25.

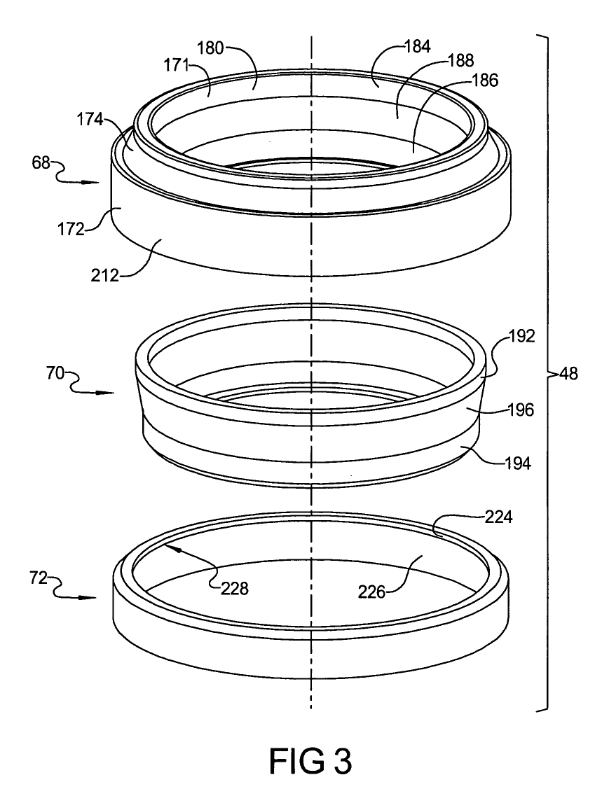

Referring now to FIGS. 3, 4A and 4B, details of seal 48 are shown. Each seal 48 includes an annular resiliently compressible retaining member 68 and two rigid annular inserts 70, 72 disposed therein. Retaining member 68 can be made of a variety of materials. Such materials include, but are not limited to, AEM, NBR, XNBR, HNBR, ACM, and FKM. The rigid inserts can be made from a variety of materials. Such materials include, but are not limited to, 1050 stamped steel, 1008 steel, 1010 steel, nylon 66, brass, high temperature plastics, and powdered metals.

As used herein, the terms top/bottom, vertical/horizontal, radial/axial, and other similar terms are used to describe the relative orientations of the various components of the present invention. Accordingly, such terms are relative terms and are based upon the orientation of the components depicted in FIGS. 3, 4A and 4B. Thus, these terms are not to be construed as absolute terms and need to be interpreted in light of their usage within the preceding and subsequent text and the views depicted in FIGS. 3, 4A and 4B. Furthermore, axes 38a, 38b are referred to as axial axis and, thus, the terms axial and radial are relative to axis 38a and/or 38b.

Cup 42 has a flat bottom 80 with a generally cylindrical sidewall 82 extending therefrom and defining an interior cavity 83. An outer shoulder 88 in outer surface 84 extends radially inwardly and forms a first sealing surface 94 between cup 42 and seal 48, as described in more detail below. The outer surface of an upper extension 100 of sidewall 82 forms a second sealing surface 102 between cup 42 and seal 48, as described in more detail below. A pawl 108 extends radially outwardly from the outer surface of extension 100 and includes an edge or barb 110. A top edge 116 of extension 100 forms a third sealing surface between cup 42 and seal 48, as described in more detail below. The inner surface of extension 100 includes a tapering portion 122 and a vertical portion 124. A shoulder 126 is formed on an inner surface 128 of sidewall 82 adjacent vertical portion 124 of extension 100. Another shoulder 136 is located on inner surface 128 adjacent a bottom surface 134 of cavity 83.

Spacer 58 is disposed within cavity 83 of cup 42 on bottom surface 134. Spacer 58 is preferably either circular or annular although other shapes can be used. Spacer 58 includes a lip 140 that extends upwardly from the outer edge of spacer 58. When assembled, spacer 58 is flush against both bottom surface 134 of cavity 83 and against the bottom surface of trunnion 36. Spacer 58 thereby forms a tight joint between trunnion 36 and bottom surface 134 of cup 42. Spacer 58 has a plurality of radially extending channels (not shown) to allow grease to move around within cavity 83 of cup 42. Shoulder 136 limits radial movement of spacer 58.

Bearings 56 are disposed within cavity 83 of cup 42 and may reside on lip 140 of spacer 58 and/or shoulder 136. Bearings 56 contact both trunnion 36 and cup 42. Bearings 56 facilitate relative movement between cup 42 and trunnion 36.

Seal 48 completes cup assembly 22 and, when pressed onto cup 42, forms a mechanical loading and seals against sealing surfaces 94, 102, 118, as described in more detail below. Seal 48 can be manually placed on cup 42 without the use of machinery.

Cup assembly 22 is disposed on the outer periphery or surface of trunnion 36. Trunnion 36 is generally cylindrical. The outer surface of trunnion 36 includes four radially tapering sections 142, 144, 146, 148 and four axially extending straight sections 150, 152, 154, 156. The outer surface of trunnion 36 also includes a chamfer 166 adjacent to an end 168 of trunnion 36. A reservoir 170 is disposed in end 168 of trunnion 36. Reservoir 170 acts as a storage for grease. The contour of the outer surface of trunnion 36 allows for a relatively high mechanical loading to be imparted between trunnion 36 and seal 48, as described in more detail below.

Retaining member 68 has radially spaced apart first and second annular legs 171, 172 interconnected by a flexible bridge 174. An annular cavity 176 exists between legs 171, 172. First leg 171 is disposed radially inwardly from second leg 172. First and second legs 171, 172 each have multiple compressible sealing surfaces that respectively engage with the outer surface of trunnion 36 and with cup 42. First annular insert 70 is disposed within first leg 171 while second annular insert 72 is disposed within second leg 172. First and second inserts 70, 72 limit radial movement of portions of first and second legs 171, 172. First and second legs 171, 172 in conjunction with inserts 70, 72 impart sealing forces in a radially inward direction and of differing magnitudes. That is, first and second legs 171, 172 allow for two separate loads to be applied by seal 48. Legs 171, 172 also impart an axial sealing force(s). First leg 171 in conjunction with insert 70 forms a static seal against trunnion 36 while second leg 172 in conjunction with insert 72 forms a dynamic seal against cup 42 which may move or oscillate relative to seal 48 during rotation of components 26, 28. This sealing arrangement retains grease within and keeps contaminates out of cavity 83 of cup 42.

First leg 171 has radially opposite inner and outer surfaces 180, 182. Inner surface 180 has two straight sections 184, 186 (generally parallel with axial axis 38b) and a radially tapering section 188 therebetween. Similarly, first insert 70 has a pair of straight sections 192, 194 (generally parallel with axial axis 38b) and a radially tapering section 196 therebetween. Straight sections 192, 194 and tapering sections 196 of first insert 70 are respectively generally aligned with straight sections 184, 186 and tapering section 188 of inner surface 180 of first leg 171. First leg 171 and first insert 70 are dimensioned to cause inner surface 180 of first leg 171 to compress and deform against the outer surface of trunnion 36. First leg 171 and first insert 70 form a static seal against trunnion 36 with first insert 70 limiting radially outward deformation of first leg 171. Specifically, straight sections 184, 186 respectively engage, compress, and seal against straight sections 184, 186 of trunnion 36 while tapering section 188 engages, compresses, and seals against tapering section 146 of trunnion 36. The uncompressed dimensions of inner surface 180 of first leg 171 are represented in phantom on trunnion 36 in FIG. 4B. The contour of inner surface 180 of first leg 171 and that of first insert 70 limits the axial position of seal 48 on trunnion 36. The outer surface 182 of first leg 171 is dimensioned and contoured to provide a gap 200 between outer surface 182 and the inner surface of extension 100 of cup 42. A bottom surface 202 of first leg 171 in conjunction with a bottom section 204 of first insert 70 limit axial movement of bearings 56 within cup 42.

Second leg 172 has radially opposite inner and outer surfaces 210, 212. Inner surface 210 has two straight sections 214, 216 (generally parallel with axial axis 38b) with a radially extending flat section 218 therebetween. A bump or projection 220 extends radially inwardly from the lower portion of inner surface 210. A radially flat bottom surface 222 of second leg 172 extends between inner and outer surfaces 210, 212. Similarly, second insert 72 has a pair of straight sections 224, 226 (generally parallel to axial axis 38b) and a radially extending flat section 228 therebetween. Straight sections 224, 226 and flat section 228 of second insert 72 are respectively generally aligned with straight sections 214, 216 and flat section 218 of inner surface 210 of second leg 172. Second leg 172 and second insert 72 are dimensioned to cause the inner and bottom surfaces 210, 222 of second leg 172 to compress and deform against cup 42 and form a dynamic seal therebetween with second insert 72 limiting radially outward and axially upward deformation of second leg 172. Specifically, second leg 172 and second insert 72 are configured to cause radially flat sections 218, 222 and projection 220 to respectively engage, compress, and seal against top edge 116 of extension 100 at third sealing surface 118, outer shoulder 88 of cup sidewall 82 at first sealing surface 94, and on the outer surface of extension 100 at second sealing surface 102. The uncompressed dimensions of radially flat sections 218, 222 and projection 220 are represented by the broken lines in FIG. 4B imposed on cup 42.

The contours and dimensions of first and second legs 171, 172 and that of first and second inserts 70, 72 are designed to provide a static seal against trunnion 36 and a dynamic seal against cup 42. To achieve this, the contours and dimensions are set so that the mechanical loading that occurs between the first leg 171 and trunnion 36 is greater than the mechanical loading that occurs between second leg 172 and cup 42.

Compressible bridge 174 allows for relative movement between first leg 171 and second leg 172 during rotation of components 26, 28. Bridge 174 is flexible and, thus, can be in compression or tension during rotation of components 26, 28. Preferably, seal 48 and bridge 174 are dimensioned and configured so that bridge 174 is always in compression. Bridge 174 allows for variations in loads between first leg 171 and second leg 172. Bridge 174 provides seal flexibility between first leg 171 and second leg 172 and allows second leg 172 to maintain a dynamic sealing against cup 42 during rotation of components 26, 28. Cavity 176 facilitates relative movement between first and second legs 171, 172 and allows cup 42 to have some radial movement and to realign itself when necessary. Cavity 176 also functions as a reservoir for grease. The compressible nature of bridge 174 can also allow for some axial movement between cup 42 and trunnion 36. However, such axial movement may be restricted by the engagement of spacer 58 with cup 42 and trunnion 36.

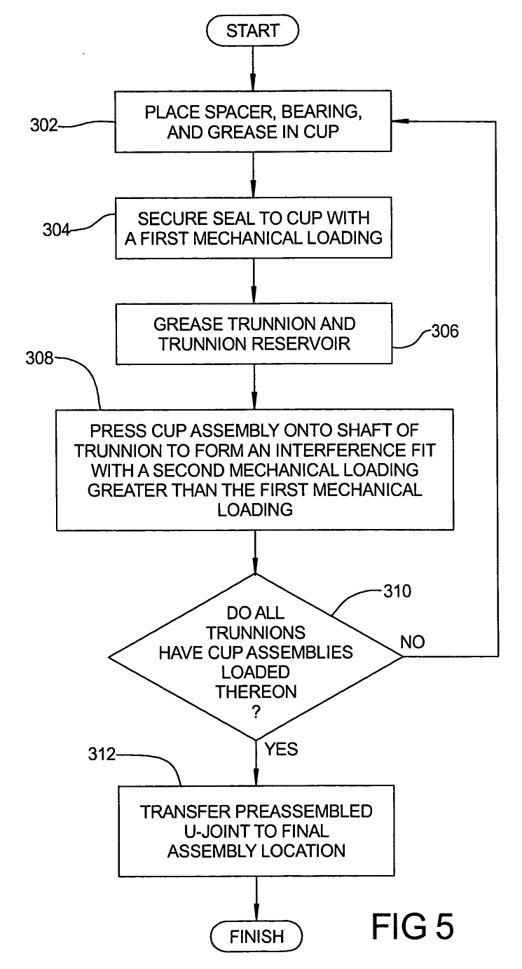

The design of seal 48 advantageously facilitates the preassembly of U-joint 20 at one location and the subsequent movement of the preassembled U-joint to a final assembly location. The final assembly location can be the same as the preassembly location, an adjacent location, or a remote location. The static sealing against the trunnion and the dynamic sealing against the cup allows the preassembled U-joint to be moved or transferred with a reduced propensity to inadvertently come apart. Additionally, barb 110 can engage with projection 220 on second leg 172 to help retain seal 48 on cup 42 during transport. A method of preassembling U-joint 20 is shown in FIG. 5. The preassembling of U-joint 20 includes securing four cup assemblies 22 to four trunnions 36 of a single spider 24.

To begin, spacer 58, bearings 56, and grease are disposed within cup 42, as indicated in block 302. Spacer 58 lays flat against inner bottom surface 134 of cup 42. Greased bearings 56 are disposed within cup 42 on the top of spacer 58. Additional grease may be disposed within cup 42 as desired.

Seal 48 is secured to cup 42 with a first mechanical loading, as indicated in block 304. Seal 48 can be manually secured to cup 42 by human force or, alternatively, with mechanical assistance or in an automated process. Seal 48 is secured to cup 42 with portions of seal 48 engaging with cup 42 at outer shoulder 88, outer surface of extension 100, pawl 108, and top edge 116 of extension 100. Dynamic seals, which seal against a relatively moveable surface, are formed in at least three seal locations, first sealing surface 94, second sealing surface 102, and third sealing surface 118, of cup 42. Projection 220 and second sealing surface 102 in conjunction with barb 110 of pawl 108 provide seal retention on cup 42 during handling before final assembly. The use of barb 110 is advantageous in that it impedes the inadvertent separation of cup 42 from seal 48. That is, barb 110 prevents cup 42 from easily being removed from seal 48.

Trunnion 36 and reservoir 170 are greased, as indicated in block 306. Grease is applied to trunnion 36 and inserted into reservoir 170. Cup assembly 22 is then positioned and pressed onto trunnion 36, as indicated in block 308. This forms an interference fit with a second mechanical loading that is greater than the first mechanical loading of seal 48 to cup 42. The second mechanical loading may also be applied by human force, with mechanical assistance or in an automated process. The retaining of cup 42, seal 48, and trunnion 36 as a preassembly is accomplished by the interference fit between first leg 171 of seal 48 and the outer surface of trunnion 36. The interference fit provides cup assembly 22 alignment with and retention to trunnion 36 through final assembly.

This process is continued until each trunnion 36 has a cup assembly 22 disposed thereon, as indicated in decision block 310. If any trunnion 36 lacks a cup assembly 22, the preassembly repeats the process indicated in blocks 302-310. Once all trunnions 36 of spider 24 have cup assemblies 22 secured thereto, the preassembled U-joint can be transferred to the final assembly location, as indicated in block 312. The preassembled U-joint can then be fixed within openings 34 of yokes 25. If it is desired to remove cup assembly 22 from trunnion 36, such as at the final assembly location, it is preferred that an axial force be imparted to the top of seal 48, and even more preferably, to the top of first leg 171.

The preceding description of the present invention refers to the specific configuration and orientation shown in the preferred embodiment. It should be appreciated, however, that deviations, changes and alterations to the present invention can be employed without departing from the spirit and scope of the present invention. For example, while the present invention is shown as having two annular inserts 70, 72, it should be appreciated that additional inserts may be employed, although all the benefits of the present invention may not be realized. Additionally, while the U-joint is shown as coupling two shafts 26, 28 together, it should be appreciated that the U-joint of the present invention is not limited to shafts, but can be used to couple other types of rotating members together. Additionally, while seal 48 is shown as providing at least three distinct sealing surfaces on both cup 42 and trunnion 36, it should be appreciated that the number of sealing surfaces can vary, although all of the benefits of the present invention may not be realized.

It should further be appreciated that while spacer 58 is dimensioned to provide a tight joint between trunnion 36 and bottom surface 134 of cup 42, it may be desirable to use a biasing member or a member having biasing characteristics to allow for some axial movement between trunnion 36 and cup 42 while still maintaining a secure enough engagement to prevent undesirable vibration and/or out-of-balance conditions during rotation of components 26, 28. That is, spacer 58 may be replaced with a spring-type member that applies an axial loading of a predetermined magnitude between cup 42 and trunnion 36. The spring-type member will allow some axial movement between cup 42 and trunnion 36 without causing undue vibration or out-of-balance conditions during operation. Furthermore, if desired, spacer 58 could remain as is or be slightly narrowed in dimensions and bridge 174 of seal 48 can act as a spring member allowing some axial movement between cup 42 and trunnion 36 while applying an axial preload of a predetermined magnitude. Bridge 174 will thereby limit the axial movement and bias trunnion 36 and cup 42 into a desired orientation. By allowing some axial movement between cup 42 and trunnion 36, it is believed that the heat generation within U-joint 20 can be reduced without being so loose as to cause detrimental vibration and/or out-of-balance conditions.

Thus, the description of the invention is merely exemplary in nature and variations that do not depart from the gist of the invention are intended to be within the scope of the invention. Accordingly, such variations are not to be regarded as a departure from the spirit and scope of the invention.

What is claimed is:

1. A seal comprising:
a compressible retaining member having radially spaced apart first and second legs;
at least one sealing surface on the first leg;
at least one sealing surface on the second leg;
a first insert at least partially disposed within the first leg, the first insert limiting radial movement of at least a portion of the first leg; and
a second insert at least partially disposed within the second leg, the second insert limiting radial movement of at least a portion of the second leg.

2. The seal of claim 1, wherein the first and second legs impart radial sealing forces in a same radial direction.

3. The seal of claim 2, wherein the first and second legs impart radial sealing forces in a radially inward direction.

4. The seal of claim 2, wherein the first leg imparts a sealing force of a first magnitude and the second leg imparts a sealing force of a second magnitude different than the first magnitude.

5. The seal of claim 1, wherein the compressible retaining member includes a bridge that interconnects the first and second legs.

6. The seal of claim 5, wherein the bridge is in compression.

7. The seal of claim 1, wherein the first leg is disposed radially inwardly from the second leg.

8. The seal of claim 1, wherein the first leg imparts a radial sealing force and the second leg imparts at least one of a radial sealing force and an axial sealing force.

9. The seal of claim 1, wherein the first and second inserts are annular inserts.

10. The seal of claim 1, wherein at least one of the first and second inserts comprises metal.

11. The seal of claim 1, wherein the sealing surface on the first leg is a static sealing surface and the sealing surface on the second leg is a dynamic sealing surface.

12. The seal of claim 1, wherein the second insert has a radially inwardly extending portion that limits axial movement of a cup in a U-joint.

13. The seal of claim 1, wherein the first and second inserts are rigid inserts.

14. A seal comprising:
a first leg having at least one sealing surface operable to provide a static seal against a relatively stationary surface;
a second leg having at least one sealing surface operable to provide a dynamic seal against a relatively moving surface; and
a flexible bridge interconnecting the first and second legs and allowing relative movement therebetween.

15. The seal of claim 14, further comprising first and second rigid inserts, the first rigid insert at least partially disposed within the first leg and limiting radial movement of at least a portion of the first leg, and the second rigid insert at least partially disposed within the second leg and limiting radial movement of at least a portion of the second leg.

16. The seal of claim 14, further comprising a single rigid insert at least partially disposed within in at least one of the first and second legs.

17. The seal of claim 14, wherein the bridge is in compression.

18. The seal of claim 14, wherein at least one sealing surface on each of the first and second legs is compressible.

19. The seal of claim 14, wherein at least one sealing surface on the second leg dynamically seals against an oscillating surface.

20. The seal of claim 14, wherein the first leg is disposed radially inwardly from the second leg.

21. A sealing system for a U-joint, the sealing system comprising:
a compressible sealing member having radially opposite inner and outer perimeters, the inner perimeter operable to engage with and seal against a U-joint trunnion; and
a rigid annular member at least partially disposed within the sealing member, the annular member limiting radially outward movement of a portion of the inner perimeter of the sealing member,
wherein the sealing member and the annular member form an interference fit on the U-joint trunnion.

22. The sealing system of claim 21, wherein the rigid annular member is a first rigid annular member and further comprising a second rigid annular member disposed radially outwardly from the first annular member and at least partially disposed within the sealing member.

23. The sealing system of claim 22, wherein the sealing member has radially spaced apart first and second legs, the first annular member is at least partially disposed in the first leg, the second annular member is at least partially disposed in the second leg, the first leg forms a static seal against a U-joint trunnion, and the second leg forms a dynamic seal against a U-joint cup.

24. The sealing system of claim 23, wherein the second leg has a radially extending projection that is engageable with a barb on the U-joint cup and impedes separation of the sealing member from the U-joint cup.

25. A method of preassembling a U-joint, the method comprising;
(a) securing a compressible sealing member on a cup with a portion of the sealing member engaging a wall of the cup;
(b) positioning the cup and the sealing member on a trunnion;
(c) forming a compressible interference fit between the sealing member and an outer surface of the trunnion thereby retaining the cup, the sealing member, and the trunnion together as a secured assembly; and
(d) moving the secured assembly to a final assembly location.

26. The method claim of 25, wherein (a) includes securing the sealing member to the cup with a first mechanical loading and (c) includes retaining the cup, the sealing member, and the trunnion together with a second mechanical loading greater than the first mechanical loading.

27. The method of claim 26, wherein (a) includes forming the first mechanical loading by limiting radial movement of a first portion of the sealing member with a first rigid annular insert at least partial disposed in the sealing member, and (c) includes forming the second mechanical loading by limiting radial movement of a second portion of the sealing member with a second rigid annular insert at least partially disposed in the sealing member radially inwardly of the first rigid annular insert.

28. The method of claim 25, wherein (a) includes engaging the sealing member with the wall of the cup in at least three distinct locations.

29. The method of claim 25, wherein (c) includes forming a static seal between the sealing member and the outer surface of the trunnion.

30. The method of claim 25, wherein (a) includes impeding removal of the sealing member from the cup with a barb on the cup that is engageable with a feature on the sealing member.
